(19) United States
(12) Patent Application Publication
(10) Pub. No.: US 2003/0225922 A1
(43) Pub. Date: Dec. 4, 2003

(54) Parallel multi-configurational self-consistent field code

(75) Inventor: Graham D. Fletcher, Sunnyvale, CA (US)

Correspondence Address: John P. Wooldridge, 1334 Ridgestone Court, Livermore, CA, 94551, US

(73) Assignee: The Eloret Corporation

(21) Appl. No.: 10/447,069

(22) Filed: May 28, 2003

Related U.S. Application Data
(60) Provisional application No. 60/385,436, filed on May 28, 2002.

(51) Int. Cl. G06F 9/46

(52) U.S. Cl. 709/312; 709/313

(57) ABSTRACT

A system and method for Multi-Configurational Self-Consistent Field (MCSCF) calculations to be executed on multiple nodes whereby the work load and data storage requirements are shared between the nodes/processors.

This application claims priority to U.S. Provisional Patent Application Serial No. 60/385,436, titled “Parallel Multi-Configurational Self-Consistent Field Code,” filed May 28, 2002 and incorporated herein by reference.

The invention described herein was made by a nongovernment employee, whose contribution was done in the performance of work under a NASA contract, and is subject to the provision of Section 305 of the National Aeronautics and Space Act of 1958, Public Law 85-568 (72 Stat. 435; 42 U.S.C. 2457).

### BACKGROUND OF THE INVENTION

1. Field of the Invention

The present invention relates to Multi-Configurational Self-Consistent Field (MCSCF) Calculations, and more specifically, it relates to the use of parallel processing in MCSCF.

2. Description of Related Art

Multi-Configurational Self-Consistent Field (MCSCF) Calculations enable the theoretical study of chemical reactions in which bonds are broken and formed. However, such calculations are computationally expensive. Previously, MCSCF calculations were restricted to running on a single processor and calculations would take many weeks. In order to exploit the power of multiple processors simultaneously—parallel computing—a new parallel version of the code is needed. The parallel version of a code must succeed in distributing the computational work and data storage requirements evenly amongst the processors in order to achieve good “scalability” (the improvement of performance with increasing numbers of processors and ability to handle larger problems) and is often substantially different from conventional code.

The Hessian matrix required for some MCSCF equations is very large. However, not every element of the matrix is actually needed. For instance, molecular symmetry may cause several elements to be the same as others and therefore redundant. In general, this applies to whole rows and columns at a time, so a list can be made of which rows or columns are redundant. Because of this, a redundancy test is normally performed whenever a contribution to the Hessian is about to be calculated. The redundancy test is performed using conditional programming statements such as IF . . . Then statements. Using these types of conditional statements yields inefficient code because it interrupts the use of instruction pipelining.

### SUMMARY OF THE INVENTION

It is an object of the present invention to provide a system of Parallel Multi-Configurational Self-Consistent Field code.

It is another object to provide a method of Parallel Multi-Configurational Self-Consistent Field computation.

These and other objects will be apparent based on the disclosure herein.

The Distribution of data required for the parallel MCSCF code is achieved using a specially designed toolkit called the distributed data interface (DDI) that implements portable one-sided memory copy operations using message passing to simulate a shared memory environment on a distributed memory architecture if necessary. The Distributed Data Interface permits storage of large data arrays in the aggregate memory of distributed memory, message passing computer systems. The design of this relatively small library is discussed, in regard to its implementation over SHMEM, MPI-1, or socket based message libraries.

The present invention enables the ability to distribute work and data over many processors for a MCSCF-Type calculation in such a way as to achieve good “scalability” with the number of computer processors and portability to different platform architectures. All major steps of the parallel MCSCF make use of the DDI software library. An important step in the MCSCF method involves the construction of a large matrix know as the “Hessian”. A novel indexing scheme for the construction of the elements of the Hessian renders this step more efficiently.

### BRIEF DESCRIPTION OF THE DRAWINGS

FIG. 1 shows a memory module if one is using a full function one-sided messaging library.

FIG. 2 shows a two-process model for distributed data management.

FIG. 3 is a schematic representation of the Distributed Data Interface of the present invention.

FIG. 4 is a schematic representation of a Parallel Direct 4-index Transformation under the present invention.

### DETAILED DESCRIPTION OF THE INVENTION

The Distribution of data required for the parallel MCSCF code is achieved using a specially designed toolkit called the distributed data interface (DDI). A DDI implements portable one-sided memory copy operations using message passing and, in so doing, can simulate a shared memory environment on a distributed memory architecture if necessary. This greatly assists the development of parallel codes. The distribution of work required to form the various parameters and matrices of the MCSCF method is then largely based upon the distribution of data.

The Distributed Data Interface permits storage of large data arrays in the aggregate memory of distributed memory, message passing computer systems. The design of this relatively small library is discussed, in regard to its implementation over SHMEM, MPI-1, or socket based message libraries. The good performance of a MP2 program using DDI has been demonstrated on both PC and workstation cluster computers, and some details of the resulting message traffic are presented below.

See “A Parallel Second-Order Moller-Plesset Gradient,” GRAHAM D. FLETCHER, et al., MOLECULAR PHYSICS, 1997, VOL. 91, NO. 3,431±438 (incorporated herein by reference) for a description of a second order Moller-Plesset (MP2) energy gradient algorithm for distributed memory parallel computers. A direct approach is used in that integrals are recalculated as required, but the degree of recalculation is minimized by exploiting the large global memory typically available on parallel machines. Results, obtained using up to 256 processors of the Cray T3D show very good scalability, with over 99.5% parallelism

It is axiomatic in the modern world that computing is a major force behind scientific and engineering progress, and further, that the truly revolutionary advances in computation required for its full fruition are possible only by full exploitation of parallel processing.

Parallel processors offer increased CPU performance, greater aggregate memory, and in a proper hardware design, increased bandwidth to disk as well as increased disk storage. It is the task of the application programmer to exploit all such resources. However, porting of an existing sequential application to parallel hardware frequently involves the same memory storage pattern as for single node runs, as this is the simplest approach. In fact early efforts to run the quantum chemistry package GAMESS [1] in parallel used replicated storage models for Fock operators and density matrices [1], work arrays for integral transformations [2], orbital Hessians during analytic nuclear Hessian computations [3], etc. Thus, while GAMESS was exploiting the additional processors and, by dividing integral files over nodes onto separate disk devices, the additional disk storage, it was not utilizing the increased total memory. For the past four years the simple point-to-point messages and global operations within either MPI-1 [4] or the older TCGMSG [5] libraries have been used to transport messages between nodes to support the replicated memory version of GAMESS.

It was apparent that it was difficult to exploit parallel computers for correlated wavefunctions with large basis sets using replicated memory, due to the requirement that every node have sufficient memory to solve the problem (albeitmore slowly than in parallel). This led to the development of a MP2 energy and gradient program that exploits the full memory of the machine [6,7]. The latter article [7] discusses from an algorithmic viewpoint all steps in transforming integrals to the MO basis, constructing the Lagrangian and solving the Z-vector response equation, and back-transforming amplitudes to give the non-separable density elements. Full details of how each of these data structures are distributed across the memory of all nodes were given. However, that article [7] does not discuss any details of the mechanism for distributed storage. An exemplary discussion is herein given of the implementation specifics for the Distributed Data Interface (DDI), which was created to support this MP2 algorithm. Secondly, it is demonstrated that DDI can be used not just on large parallel machines, but on considerably less expensive clusters of networked workstations and PCs as well.

There have been several other efforts in electronic structure theory to exploit the global memory of parallel machines. These include distributed storage versions of SCF [8-12], analytic SCF Hessians [13], MP2 [6,7,14-19], CI [20,21], and Coupled-Clusters [22,23] codes. Many but not all of these algorithms are run using an ambitious library to support distributed memory usage, the Global Array (GA) tools [24,25]. GA was written to support NWChem [26], whose primary design goal is to pursue distributed memory usage. Electronic structure work prior to efforts to utilize distributed memory have been reviewed [271, in an article that also attempted to anticipate how this would be exploited. An assessment of memory models and other considerations relating to parallel quantum chemistry is available [28].

Hardware Considerations

The key assumption in the decision to implement DDI is that the parallel computer introduces a new memory class between main memory and disk memory, in terms of both storage capacity and time for access:

registers<caches<main memory

<remote memory<disk <tape

It has been claimed that, with sufficient hardware cache coherence and operating system migration of data between SMP enclosures, that the programmer can ignore the distinction between main and remote memory. However, most systems have significantly slower access time to remote memory than to local memory, so we do draw this distinction in DDI. The present low-end network technology is Fast Ethernet (100 mbit/sec), but this is expected to be superseded by Gigabit Ethernet (1000 mbit/sec) as costs fall, perhaps as early as 2000. These theoretical rates of 12.5 to 125 MB/sec seem likely to stay comfortably ahead of disk access rates, with individual Ultra-2/wide SCSI spindles typically at 20-25 MB/sec. Of course in specialized parallel machines we expect even faster remote memory access than is provided by these Ethernet communications, rendering disk storage even more clearly slower. Elementary consideration of costs also places the likely storage capacities of remote memory intermediate between local memory and disk memory.

The present trend in computer architecture is clearly headed towards clusters of SMP nodes, and this blurs the distinction between remote and local memory to a considerable extent. For simplicity, in the present paper an SMP system is viewed as consisting of individual processors, each having its appropriate share of the main memory, disk memory, and access to the network.

The current work focuses on systems in common use in the United States. Large-scale parallel computers in the US are primarily the IBM SP, Cray T3E, and SGI Origin. Each is connected by a custom network and has reasonable scalable access to disk storage. In addition, machines in this class have extensive software support for parallel programming.

Since individual research groups and departments are unlikely to have sufficient resources to own one of these large machines, the use of clusters of workstations connected by commodity networks is also of interest. This means both Unix workstations from a traditional vendor, but also PC clusters of the Beowulf type [29], and we will discuss each type.

The first of these is a cluster of dual processor IBM RS/6000 model 260 systems, which are based on 200 MHz Power3 64 bit chips and which are connected by both Fast and Gigabit Ethernet cards. These cards are connected to appropriate Ethernet switches, so that dynamically created, private, point-to-point message channels are available for multiple pairs of communicating nodes. The operating system is AIX, a vendor-quality Unix, with a FORTRAN compiler tuned for the chip's instruction set. In addition, the MPI-1 library from IBM's SP product line is available for use.

The second cluster is a set of 16 Pentium II PC systems, with an additional machine serving as a file server and compiling node. While 32 bit PC systems operating under Linux are less robust than vendor workstations, they are also substantially less expensive, due to their commodity nature. The PC cluster described here was constructed to yield an inexpensive but large aggregate memory, so its sixteen compute nodes total 8 Gbytes. Network connections between these nodes are switched Fast Ethernet.

On clusters of workstations, be they vendor quality or PCs, one does not currently expect to find good parallel programming tools. However, since they are Unix operating systems, each should have a TCP/IP socket library.

The DDI Software Implementation

Ideally the second generation MPI-2 library would be used [30], as this library includes the key programming constructs for remote memory access. MPI-2 includes MPI_WIN CREATE to dedicate some of each node's memory to distributed storage, and three crucial operations. Two of these are MPI_PUT and MPI_GET, which store data to and retrieve data from the distributed array. These may be thought of as analogous to disk WRITE and READ operations. Thus, arithmetic may not be performed directly on the distributed data, as one would with values in local memory; instead values must be fetched and stored as needed for computation. However, since there is an intelligent processor connected to the memory, it is possible to sum new contributions into an existing distributed data structure, by the call MPI_ACCUMULATE, which has no analog in conventional disk I/O.

However, to date no US vendor's MPI product offers these so-called “one-sided”, or “active” message routines from the MPI-2 specification. Given the very slow vendor adoption of MPI-1, it is not sensible to speculate when MPI-2 might be widely available. OpenMP [31] may one day present a viable alternative to MPI-2. As was the case prior to the widespread availability of MPI-1, one recourse is the use of vendor specific libraries, such as SHMEM on the Cray T3E or LAPI on the IBM SP. However, these short-term solutions are not very general, so one might utilize a more portable library such as Global Arrays [24, 25], or else write one's own software. We have chosen the latter option, as this permits GAMESS and DDI to be distributed in a bundle, with control language for compilation and execution conveniently provided. In addition, no possible conflicts can arise later from possible changes to a message passing library developed elsewhere. At present DDI contains only the basic distributed memory calls, described below, and therefore lacks certain higher-level functions such as matrix multiplication and matrix diagonalization that are included with GA.

In order to isolate the quantum chemistry application GAMESS from any particular messaging library, a new application programming interface (API) has been designed. The routines present in DDI are summarized in Table 1. Every call in this API begins with the letters DDI, making it easy to locate all parallel constructs in the application code. The code implementing the DDI calls is collected in small interface files that translate these application level calls to the appropriate lower level routines that accomplish the needed tasks.

DDI includes the traditional global operations and point-to-point messages that one would expect. Routines DDI_CREATE and DDI_DESTROY allocate and deal locate distributed data structures. At present DDI supports only doubly subscripted FORTRAN arrays, with complete columns stored on any particular node, in keeping with the normal FORTRAN storage convention. The workhorse distributed memory access routines are DDI_PUT, DDI_GET, and DDI_ACC, which deal with “patches” of memory within the large distributed array. Note that when a patch falls across the memory of two or more nodes, it is treated as separate subpatches. In general these three routines cloak details about which node's memory actually stores the patch of data. However, since access to the portion of the distributed data, which happens to be stored locally, should be much more efficient DDI_DISTRIB reports which columns are available locally, so that algorithms can maximize their use of locally stored data.

On the Cray T3E system, DDI has been implemented over the system SHMEM library by writing a special file named DDIT3E. This file provides a nearly direct call translation from DDI to Cray's SHMEM, a full function one-sided messaging library which is relatively easy to use. Near linear speedups of the MP2 program in GAMESS to 128 nodes and beyond on the T3E have been demonstrated elsewhere [7].

TABLE 1
Summary of the Distributed Data Interface API

| | |
|---|---|
| Routine | Pupose |

Initialization/Termination

| | |
|---|---|
| DDI_PBEG (NWDVAR) | initialize DDI environment |
| DDI_NPROC (DDI_NP, DDI_ME) | number of nodes and node ID |
| DDI_MEMORY (MEMREP, MEMDDI, EXETYP) | allocate shared memory |
| region | |
| DDI_PEND (ISTAT) | make tidy or graceless exit |

Global tasks

| | |
|---|---|
| DDI_SUNC (SNCTAG) | barrier synchronization |
| DDI_GSUMF (MSGTAG, BUFF, MSGLEN) | floating point global sum |
| DDI_GSUMI (MSGTAG, BUFF, MSGLEN) | integer global sum |
| DDI_BCAST (MSGTAG, TYPE, BUFF, LEN, FROM) | broadcast data to all |
| nodes | |
| Point to point tasks | |
| DDI_SEND (SNDBUFF, LEN TO) | synchronous send |
| DDI_RECV (RCVBUFF, LEN, TO) | synchronous receive |
| DDI_RCVANY (RCVBUF, LEN, TO) | synchronous receive from any |

Dynamic load balancing (DLB)

| | |
|---|---|
| DDI_DLBRESET | reset DLB task counter |
| DDI_DLBNEXT (DLB_COUNTER) | get next DLB task counter |

Remote memory access

| | |
|---|---|
| DDI_CREATE (IDIM, JDIM, HANDLE) | create distributed matrix |
| (DM) | |
| DDI_DESTROY (HANDLE) | destroy distributed matrix |
| DDI_DISTRIB (HANDLE, NODE, ILOC, IHIC, JLOC, JHIC) | query DM |
| distribution | |
| DDI_GET (HANDLE, ILO, IHI, JLO, JHI, BUFF) | get patch of distributed |
| matrix | |
| DDI_PUT (HANDLE, ILO, IHI, JLO, JHI, BUFF) | put patch of distributed |
| matrix | |
| DDI_ACC (HANDLE, ILO, IHI, JLO, JHI, BUFF) | accumulate into patch of DM |

FIG. 1 shows the single program image model by which GAMESS runs on the T3E, and illustrates a DDI_GET operation to bring a patch of distributed memory into local memory for computation. It is instructive to consider how this happens, as it illustrates the programming difficulties one encounters in implementing this kind of functionality on different hardware. When the GAMESS application running on node 1 decides it needs a particular patch, it calls DDI_GET to obtain it. Within the DDI subroutine, a decision is made about which node actually owns that patch, meaning that the application layer need not know such details. If it happens that this patch belongs to node 0, the computations on node 0 must be interrupted long enough to obtain the patch. The actual transfer of the patch is a conventional point-to-point message. (The hardware design on the T3E includes a Block Transfer Bus to handle memory requests, rather than interrupting the main processor.) This is the origin of the terminology “active” or “one-sided”, since the procedure is driven by the requirements of node 1.

In addition to interrupt handling, one must also deal with the issue of memory locking, since if two nodes were to decide to accumulate (DDI_ACC) to the same FIG. 1. Memory model if one is using a full function one-sided messaging library. The DDI_GET interrupt of process 0 results in the data transfer to the requesting node. Patch, the one that starts first must finish before the second is allowed to accumulate its values. This is accomplished by placing a lock upon the entire portion of distributed memory on the node to which data is being accumulated, rather than attempting to lock specific subregions.

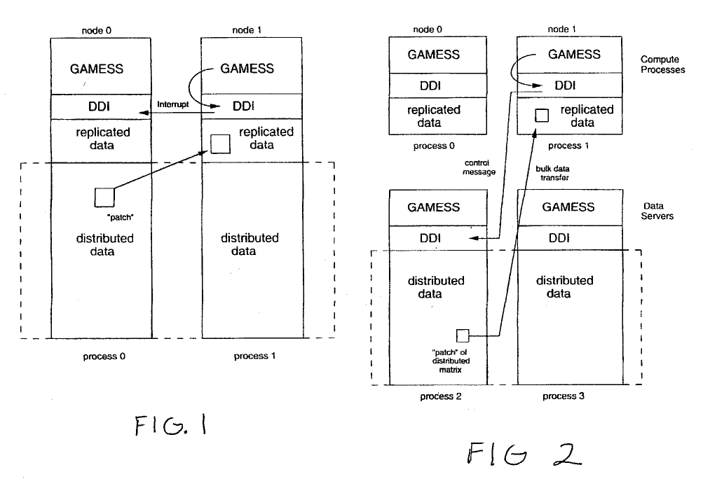

On a cluster parallel computer, a powerful active message passing library such as SHMEM is not likely to exist. As just mentioned, the use of distributed data requires the capability to interrupt computations on remote nodes momentarily to access their memory, and to guarantee exclusive access to that memory during the operations. A two-process model has been adopted to solve both problems, as shown in FIG. 2. One process, termed the “compute process”, is executing the GAMESS application and owns any replicated storage. A second process, termed the “data server”, owns the portion of the node's memory that is dedicated to the distributed data structures. This second process runs in a loop in the DDI service routine, sleeping until a data access request arrives. This scheme means the compute process is unaware of any interruption, since the operating system mediates giving the data server a time slice when a DDI service request message arrives. Memory locking is taken care of by having each data server handle only one DDI request at a time, until it is completed. Thus, the two-process model nicely finesses the need to program for these two complex system level issues.

Note that each process, whether a “compute process” or a “data server” is actually a copy of the GAMESS program. Each program decides which role it is to play based on whether its process ID is in the first or second half of the total. Ordinary operations such as global sum or broadcast involve only the first half of the processes. This is easily implemented, for example, by use of communication groups in MPI-1. At first glance it may seem wasteful to have the GAMESS application object code and local variables duplicated in the data servers, but since this code is never executed, it actually represents just a few wasted MBytes in the system swap partition. It is simpler not to deal with a separate, light-weight data server main program.

As shown in FIG. 2, each DDI distributed memory access involves two messages. The first is a “control message” of length 24 bytes specifying the type of operation and what patch is being touched. Following this short message, a “bulk data message” follows in which the entire patch is transferred. While the programmer is presumably trying to write algorithms in which the size of the patches is reasonably big, the presence of an equal number of short control messages means that low communication latency is as important as high bandwidth for DDI to function well.

The scheme depicted in FIG. 2 requires only ordinary point to point messages, and thus can be run over a variety of messaging libraries, including MPI-1 and TCP/IP sockets. MPI-1 is used as the low level messaging layer on IBM SP systems, since a significant fraction of the SP install base at the time this is written either has a switch that does not support LAPI or has not been upgraded to recent IBM software releases.

The use of two processes on a SP node is not without penalty, as older systems are rendered unable to use the special low latency MPI-1 mode which IBM terms “user space”. As the older SP systems begin to disappear, a single program image with LAPI as the “active message” support layer will be implemented, analogous to that used on the Cray T3E. Since SGI now includesMPI-1 as part of the Origin operating system, the same FORTRAN translation layer from DDI application calls to MPI-1 point to point messages will be used on this machine.

On cluster systems, MPI-1 may or may not be available, depending on the vendor and whether a license for this has been purchased. However, since the existence of TCP, IP sockets is assured, low level code to deal directly with socket messaging has been written to implement the scheme shown in FIG. 2 on low cost clusters.

Since sockets are considerably removed from the typical programming knowledge of computational chemists, a summary of the system calls needed may be of interest [32]. First one needs a program to initiate processes on all CPUs; this “kickoff” program is called DDIKICK. This is a C program, that proceeds by system calls to fork to create duplicates of itself.

Each newly generated child process then replaces itself with a new program, either direct execution of a GAMESS process on the local node by the execvp call, or by invoking rsh to generate a GAMESS process on a remote node. While rsh and its associated rhosts authentication scheme present some security concerns, this remote process generation mechanism is ubiquitous in Unix. After all GAMESS compute processes and data servers have been generated for p CPUs, DDIKICK opens a socket to each of its 2p children, and facilitates establish direct socket connections between them. Each compute process has a total of 2p sockets open, one to every data server, one to every other compute process, and one to the kickoff program. Data servers have just p C 1 sockets, one to every compute process and one to the kickoff program. There is, of course, no need for a socket connecting pairs of data servers. Inter-child socket establishment begins by a call to socket by both processes, then one side begins the connection by a call to connect and the other side answers by the calls bind, listen, and accept. Fortunately, once the socket connections are established, data is transferred very simply, by send and recv calls. All operations, even the simple barrier synchronization, must be built up from these two calls.

Signal and kill are used to terminate all other process in the event one exits abnormally. In its present form (see Table 1), DDI is actually quite small. The socket kickoff program DDIKICK contains 350 lines of C code (including comments).

No kickoff program is required when MPI-1 is used as the low level messaging library, since one should be included with the MPI software. The FORTRAN component of DDI is 1200 lines, and includes calls to either MPI-1 or sockets. Preprocessing this file before compilation leads to correct source for the desired message transport layer, either MPI-1 or sockets. In the event socket calls are selected, a C file for all system calls just mentioned is used, adding an additional 600 lines. When sockets are used, global operations such as synchronization or broadcast are written in FORTRAN, based on binary tree algorithms. The C portion of the DDI layer is called only for the individual point to point messages, which these more complex operations generate.

The socket code runs correctly under recent operating system versions on most US workstations: IBM RS/6000, Compaq AXP, Sun UltraSPARC, HP PA-RISC, Intel PCs running RedHat Linux, and SGI R4000 workstations. Machine dependencies in the C portion of DDI are now well identified, and commented upon in the source. Thus porting the DDI socket code to some other Unix operating system should involve less than 15 minutes with the system documentation. Because the source code of DDI is provided as an integral portion of the GAMESS package, along with control language for compilation and parallel execution, GAMESS now builds for parallel execution. Users can of course choose to run this parallel executable on one CPU if desired, using DDIKICK to initiate just one compute process and its associated one data server.

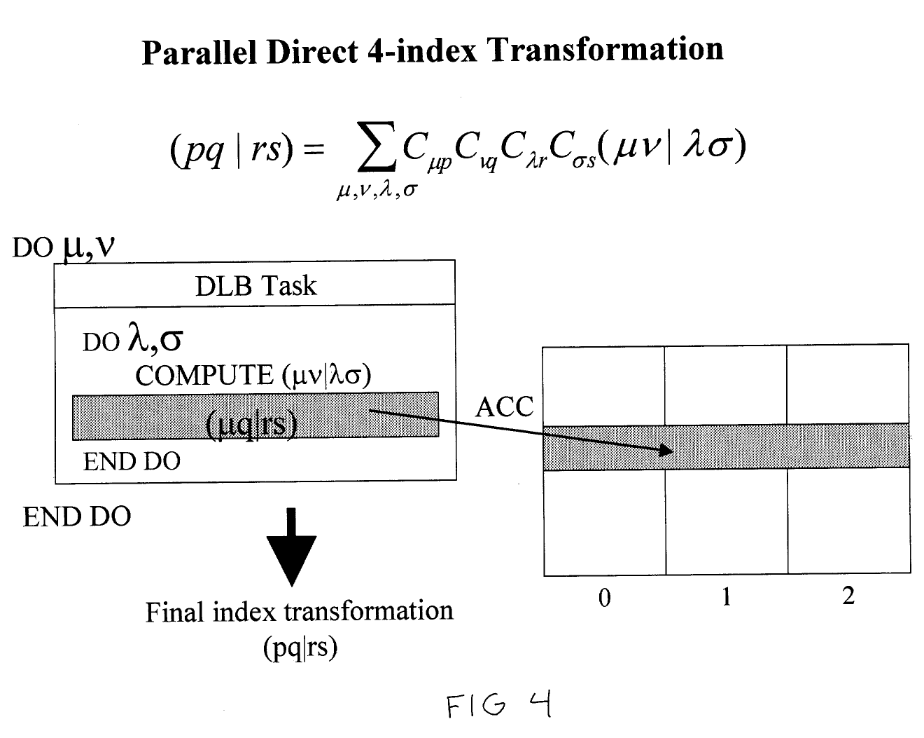

DDI is intended to serve as an interim messaging layer, pending widespread vendor adoption of MPI-2. The 1800 lines of DDI socket code linked into a GAMESS executable represent just 0.6% of the total 285,000. The DDI library is not specifically tied to GAMESS, and the functionality listed in FIG. 4 is sufficiently general to support both traditional replicated memory parallel programs, as well as distributed memory usage. However, since its use by the GAMESS application is our primary intent, DDI lacks the error checking and almost certainly some functionality that other applications might expect.

Performance on Clusters

The example chosen to illustrate performance is a quinone, previously studied in this group to understand its stereospecific Diels-Alder reaction in the total synthesis of hongconin, a cardioprotective natural product [33]. The basis set is 6-31G.d/[34], with 245 AOs, 15 frozen cores, and 39 correlated valence orbitals. Both the MP2 energy and its gradient are evaluated. The example was chosen to fit well on the 16 node PC cluster described above, with a minimum of three 512 MB nodes needed to aggregate the required distributed memory of 156 million words. Speedups from 3 to 12 or from 4 to 16 nodes may be used to judge how close to a four-fold improvement is realized. The timing results on the PC and IBM workstation clusters are shown in Table 2. Converged SCF orbitals were provided in the input to minimize time in SCF iterations. Performance on the PC cluster is quite satisfactory, in view of the very low cost of the Fast Ethernet communications network.

Since the MP2 code is fully direct, the lost wall clock time on the clusters is not due to disk I/O, but rather must be due to messaging delays. Note that the wall clock time losses are considerably smaller on the Cray T3E, with its high performance communication subsystem and efficient SHMEM library. For comparison, on 8 and 32 T3E nodes, the quinone CPU (wall) times are 3108

and 814 (850) seconds, respectively.

In order to understand the PC cluster message performance, counters were placed in the various DDI routines called by the compute processes to analyze the Ethernet data traffic needed for remote memory access. The DDI calls are classified as local if the patch is available from the local data server. Remote means that the patch is on one or more of the other nodes, but not all of them. Global means that the subpatches involve communication with all data servers to access one or more entire rows of the distributed matrix. Of course, remote and global DDI operations involve sending data on a Fast Ethernet cable, for which the theoretical maximum bandwidth is 100 mbit/sec, and therefore these are intrinsically slower than local operations.

Table 3 gives average values per node for a four node run. The sum of the average wall time required to complete all DDI requests is 1705 seconds. Adding the 315 CPU seconds consumed by a data server process accounts for 2021 seconds, a bit more than the observed loss of 1873 wall seconds in Table 2, as that table reports runs without the timing call overhead.

The maximum fluctuation for individual node timings is greatest for the global DDI_PUT, ranging from 190 to 337 seconds. All other DDI timings on individual nodes were within a few percent of the averages given in Table 3. Note that the MP2 algorithm has apparently succeeded in its design criterion, as except for remote DDI_GET operations, bulk data transfers involve 37 to 1738 Kbytes per call. The MP2 algorithm has numerous different DDI_GET operations, so it is difficult to predict their average length. Since other calls made by the MP2 algorithm [7] are more unique, it is possible to predict the message sizes.

One half of the lost wall clock time is due to remote DDI_ACC calls. However, these large messages are the most efficient, achieving over 60% of the cable bandwidth. The least efficient operation, by far, is the relatively rare global DDI_PUT calls, which clearly need to be made more efficient The relatively numerous remote DDI_GET operations also have poor bandwidth (10 mbit/sec), but due to their rather small size, are probably being limited by message latency. Table 3 indicates that it may be possible to reduce the wall time for messages by about 15% by improvements to the DDI socket code.

Table 3 also includes results taken from the dual CPU IBM cluster, to examine the advantages of Gigabit Ethernet This network adapter has a ten times greater bandwidth than the Fast Ethernet used in the PC cluster, although this is effectively halved since two processors share this card. Unfortunately, the observed application-to-application latency of Gigabit Ethernet is no better than Fast Ethernet, at about 110-120 psec in the IBM systems. The increased bandwidth has the effect of dramatically decreasing the times for large accumulate operations, while the similar latency means that other operations are not speeded up to the same extent. Because the improvement in the network technology does not keep pace with the processor improvement (the Power3 is 2.7 times faster than the Pentium II), CPU to wall clock ratios deteriorate somewhat for the IBM cluster. Similar data using the Fast Ethernet adapter in the IBM cluster is not shown in Table 2 or 3, because the observed performance for this slower adapter is very poor for p=8 and 16. This is due to contention for the shared system buffer space for each card, and indicates that any cluster using this inexpensive network technology should include one Fast Ethernet card per processor.

Accesses to data by a compute process to values stored on its local data server are frequent, especially if the algorithms attempt to maximize this. It is likely that a faster means than the Internet socket call presently in use to transfer local data can be devised, such as Unix sockets or the memcpy routine using shared memory regions. Running the data server as a thread rather than as a separate Unix process would mean that the replicated memory and the local slice of distributed memory share a common address space, making the local data copy trivial.

The experience with the dual node IBM cluster indicates some of the problems that must be faced to use SMF nodes with 4, 8, or more processors effectively. It is important that the network connection improve dramatically if a single network adapter is shared by all processors, rather than being replicated. In addition, SMP systems present the challenge of an increased number of communication channels between processes within the same enclosure, making the improvements in “local” versus “remote” communication channels mentioned in the previous paragraph even more desirable.

Conclusions and Future Work

The DDI library described herein is shown to be a portable means to support distributed memory usage by GAMESS on a variety of machines from the Cray T3E and IBM SP, to individual workstations or clusters. Speedups of 3.2 in the wall clock performance of the MP2 distributed memory code were demonstrated for fourfold increases in processor counts in a PC cluster, on a very inexpensive network. Future versions of the DDI software will contain improvements in data transport, as well as extra functionality. Future work will certainly include the application of the DDI library in other portions of GAMESS, since large data structures such as orbital Hessians, CI eigenvectors, two particle density matrices, and so forth are obvious candidates for distributed storage.

### REFERENCES

[1] M. W. Schmidt, K. K. Baldridge, J. A. Boatz, S. T. Elbert, M. S. Gordon, J. H. Jensen, S. Koseki, N. Matsunaga, K. A. Nguyen, S. Su, T. L. Windus, M. Dupuis, J. A. Montgomery, J. Comput. Chem. 14 (1993) 1347-1363.

[2] T. L. Windus, M. W. Schmidt, M. S. Gordon, Theoret. Chim. Acta 89 (1994) 77-88.

[3] T. L. Windus, M. W. Schmidt, M. S. Gordon, Chem. Phys. Lett. 216 (1993) 375-379.

[4] M. Snir, S. Otto, S. Huss-Lederman, D. Walker, J. Dongarra, MPI—The Complete Reference, Vol. 1, The MPI Core (MIT Press, Cambridge, Mass., 1998).

[5] R. J. Harrison, Int J. Quantum Chem. 40 (1991) 847-863.

[6] G. D. Fletcher, A. P. Rendell, P. Sherwood, Mol. Phys. 91 (1997) 431-438.

[7] G. D. Fletcher, M. W. Schmidt, M. S. Gordon, Adv. Chem. Phys. 110 (1999) 267-294.

8] M. E. Colvin, C. L. Janssen, R. A. Whiteside, C. H. Tong, Theoret. Chim. Acta 84 (1993) 301-314.

[9] T. R. Furlani, H. F. King, J. Comput. Chem. 16 (1995) 91-104.

[10] I. T. Foster, J. L. Tilson, A. F. Wagner, R. L. Shepard, R. J. Harrison, R. A. Kendall, R. K. Littlefield, J. Comput. Chem. 17 (1996) 109-123.

[11] R. J. Harrison, M. F. Guest, R. A. Kendall, D. E. Bernholdt, A. T. Wong, M. Stave, J. L. Anchell, A. C. Hess, R. J. Littlefield, G. L. Fann, J. Nieplocha, G. S. Thomas, D. Elwood, J. L. Tilson, R. L. Shepard, A. F. Wagner, I. T. Foster, E. Lusk, R. Stevens, J. Comput. Chem. 17 (1996) 124-132.

[12] H. A. Fruchtl, R. A. Kendall, R. J. Harrison, K. G. Dyall, Int. J. Quantum Chem. 64 (1997) 63-69.

[13] A. M. Marquez, J. Oviedo, J. F. Sanz, M. Dupuis, J. Comput. Chem. 18 (1997) 159-168.

[14] A. M. Marquez, M. Dupuis, J. Comput. Chem. 16 (1995) 395-404.

[15] D. E. Bernholdt, R. J. Harrison, J. Chem. Phys. 102 (1995) 9582-9589.

[16] I. M. B. Nielsen, E. T. Seidl, J. Comput. Chem. 16 (1995) 1301-1313.

[17] A. T. Wong, R. J. Harrison, A. P. Rendell, Theoret. Chim. Acta 93 (1996) 317-321.

[18] D. E. Bernholdt, Chem. Phys. Lett. 250 (1996) 477-484.

[19] I. M. B. Nielsen, Chem. Phys. Lett 255 (1996) 210-216.

[20] H. Daschel, H. Lishka, R. Shepard, J. Nieplocha, R. J. Harrison, J. Comput. Chem. 18 (1997) 430-448.

[21] A. J. Dobbyn, P. J. Knowles, R. J. Harrison, J. Comput Chem. 19 (1998) 1215-1228.

[22] A. P. Rendell, M. F. Guest, R. A. Kendall, J. Comput. Chem. 14 (1993) 1429-1439.

[23] R. Kobayashi, A. P. Rendell, Chem. Phys. Lett. 265 (1997) 1-11.

[24] R. J. Harrison, Theoret. Chim. Acta 84 (1993) 363-375.

[25] J. Nieplocha, R. J. Harrison, R. J. Littlefield, in: Proceedings of Supercomputing 1994 (IEEE Computer Society Press, Washington D.C., 1994) p. 340.

[26] D. E. Bernholdt, E. Apra, H. A. Fruchtl, M. F. Guest, R. J. Harrison, R. A. Kendall, R. A. Kutteh, X. Long, J. B. Nicholas, 200 G. D. Fletcher et al./Computer Physics Communications 128 (2000) 190-200 J. A. Nichols, H. L. Taylor, A. T. Wong, G. I. Fann, R. J. Little-field, J. Nieplocha, Int. J. Quantum Chem. S 29 (1995) 475-483.

[27] R. J. Harrison, R. Shepard, Ann. Rev. Phys. Chem. 45 (1994) 623-658.

[28] R. A. Kendall, Int. J. Quantum Chem. S 27 (1993) 769-779.

[29] G. F. Pfister, In Search of Clusters, 2nd edn. (Prentice-Hall, Upper Saddle River, N.J., 1998).

[30] W. Gropp, S. Huss-Lederman, A. Lumsdaine, E. Lusk, B. Nitzburg, W. Saphir, M. Snir, MPI—The Complete Reference, Vol. 2, The MPI Extensions (MIT Press, Cambridge, Mass., 1998).

[31] See http://www.openmp.org.

[32] W. R. Stevens, UNIX Network Programming, Vol. 1, Networking APIs: Sockets and XTI (Prentice Hall, Upper Saddle River, N.J., 1998).

[33] G. A. Kraus, J. Li, M. S. Gordon, J. H. Jensen, J. Org. Chem. 59 (1994) 2219-2222.

[34] R. Ditchfield, W. J. Hehre, J. A. Pople, J. Chem. Phys. 54 (1971) 724-728; P. C. Hariharan, J. A. Pople, Theoret Chim. Acta 28 (1973) 213-222.

The above references 1-34 are incorporated herein by reference.

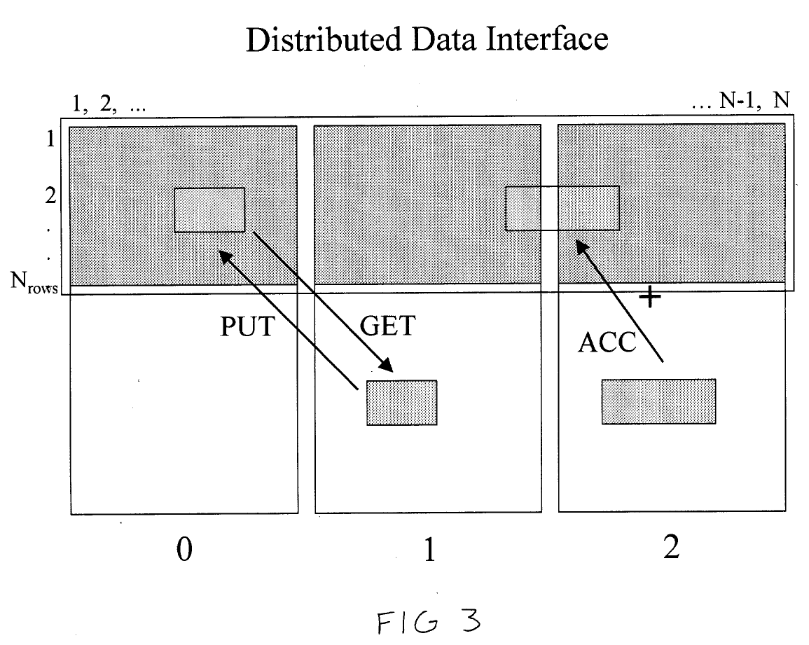

The unique features of the present innovation include the ability to distribute work and data over many processors for a MCSCF-Type calculation (e.g., Molecular Dissociation Or Fragmentation Study, etc.) in such a way as to achieve good “scalability” with the number of computer processors and portability to different platform architectures. All major steps of the parallel MCSCF make use of the DDI software library. An important step in the MCSCF method involves the construction of a large matrix know as the “Hessian”. A novel indexing scheme for the construction of the elements of the Hessian renders this step more efficiently. FIG. 3 is a schematic representation of the Distributed Data Interface of the present invention. FIG. 4 is a schematic representation of a Parallel Direct 4-index Transformation under the present invention.

The indexing scheme of the present invention avoids the repetitious execution of conditional statements, thereby improving the pipelining of instructions. Normally, the conditional statements serve to avoid redundant contributions to the Hessian. The index of the present invention causes those terms to be summed to a redundant location—a fictitious extra row of the Hessian. The index of a redundant row or column is set to be a fictitious extra row or column of the Hessian. The extra row or column is discarded at the end of the computation. All inner-loop instruction branches can be avoided in this manner, improving the overall efficiency. The computational cost of setting the indexes to fictitious values is lower than the computational cost of performing conditional statements.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A system of Parallel Multi-Configurational Self-Consistent Field code comprising:
a Distributed Data Interface Toolkit software library implementing portable one-side memory copy operations using message passing, thereby simulating a shared memory environment on a distributed memory architecture; and
an Indexing Scheme for the construction of the elements of a Hessian matrix, said Indexing Scheme causing terms to be summed to a redundant location, thereby avoiding repetitious execution of conditional statements;
wherein computer software programmed using said Distributed Data Interface Toolkit and the data to be operated on by said computer software is distributed over many computer processors, and said Indexing Scheme improves the overall efficiency of said system.

2. A method of Parallel Multi-Configurational Self-Consistent Field computation comprising:
providing a Distributed Data Interface Toolkit software library implementing portable one-sided memory copy operations using message passing, thereby simulating a shared memory environment on a distributed memory architecture; and
providing an Indexing Scheme for the construction of the elements of a Hessian matrix, said Indexing Scheme causing terms to be summed to a redundant location, thereby avoiding repetitious execution of conditional statements;
wherein computer software programmed using said Distributed Data Interface Toolkit and the data to be operated on by said computer software is distributed over many computer processors, and said Indexing Scheme improves the overall efficiency of said system.
